(19) United States
(12) Patent Application Publication
(10) Pub. No.: US 2025/0060856 A1
(43) Pub. Date: Feb. 20, 2025

(54) Resolving Mouse Cross-Screen Issues

(71) Applicant: International Business Machines Corporation, Armonk, NY (US)

(72) Inventors: Hui Gao, BEIJING (CN); Yue Chen, Beijing (CN); Yanfeng Shi, Beijing (CN); Hai Jun Xu, Beijing (CN); Huai Nan Zhou, Beijing (CN); Ying Yu, BEIJING (CN)

(21) Appl. No.: 18/235,418

(22) Filed: Aug. 18, 2023

(51) Int. Cl. G06F 3/04812; G06F 3/0354

(52) U.S. Cl. CPC G06F 3/04812; G06F 3/03543

(57) ABSTRACT

Mechanisms for performing cross-screen movement operations in a multiple display device computer configuration are provided. An input is received, from a user interface device, that specifies a movement of a displayed element on a first display screen of the multiple display device computer configuration. A path of motion of the displayed element is calculated and compared to a junction margin of the first display screen to determine if the path of motion intersects the junction margin. In response to the path of motion intersecting the junction margin, the displayed element is placed at a first point of the junction margin. In response to receiving a subsequent input having a subsequent path of motion that intersects the junction margin, performing a cross-screen movement operation moving the displayed element to an end point of the subsequent path of motion in the second display screen.

### BACKGROUND

The present application relates generally to an improved data processing apparatus and method and more specifically to an improved computing tool and improved computing tool operations/functionality for resolving mouse cross-screen issues arising from the use of multiple computer display devices.

Many users of computing devices invoke the use of dual/multiple screen capabilities to extend the space in which the computing system can render content, e.g., documents, files, windows of content, and the like. For example, various operating systems, such as Microsoft Windows available from Microsoft Corporation, have functionality and settings to allow users to enable multiple display devices to work in connection with one another as if they were a single larger display device. The display devices, also referred to as computer monitors, may be arranged in different configurations both horizontally and vertically.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for performing cross-screen movement operations in a multiple display device computer configuration. The method comprises receiving, from a user interface device, an input specifying a movement of a displayed element on a first display screen of the multiple display device computer configuration. The method comprises calculating a path of motion of the displayed element based on the input and comparing the path of motion to a junction margin of the first display screen to determine if the path of motion intersects a junction margin. The junction margin is a margin of the first display screen that virtually adjoins a margin of a second display screen of the multiple display device computer configuration. The method further comprises, in response to the path of motion intersecting the junction margin, placing the displayed element at a first point of the junction margin. In addition, the method comprises, in response to receiving a subsequent input having a subsequent path of motion that intersects the junction margin, performing a cross-screen movement operation moving the displayed element to an end point of the subsequent path of motion in the second display screen.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example block diagram of a multiple display device computing device in accordance with one illustrative embodiment;

FIG. 2 is an example diagram illustrating a cross-screen mouse cursor movement detection operation based on a double confirm action in accordance with one illustrative embodiment;

FIG. 3 is an example diagram of a non-uniform display screen margin generated in accordance with one illustrative embodiment;

FIG. 4 is a flowchart outlining an example operation for performing a cross-screen mouse cursor movement operation based on a double confirm action in accordance with one illustrative embodiment; and

FIG. 5 is a flowchart outlining an example operation for automatically adjusting margin dimensions of a display screen based on user cross-screen behavior in accordance with one illustrative embodiment.

### DETAILED DESCRIPTION

With multiple display configurations, software is provided to track movement of a user's mouse from one display to another. That is, the user may move the mouse such that the mouse cursor rendered on the display crosses from one display, or screen, to another in the multiple display configuration. However, issues arise when the cursor is moved close to a margin or boundary of one display in that such movement is interpreted to be an intent to cross screens when in fact there are times when such cross-screen movement is in fact not intended. This makes it difficult for users to work in the margins or at the edges of a displayed screen and leads to a portion of the displayed area at the periphery that cannot be easily utilized.

The illustrative embodiments provide an improved computing tool and improved computing tool operations/functionality for addressing the mouse cross-screen issues arising from movement of mouse cursors in the margins, corners, or periphery of a displayed screen in a multiple display device configuration of a computing system. With the mechanisms of the illustrative embodiments, a “double confirm” action is defined and utilized to confirm that movement of a mouse cursor within the regions at the periphery of a displayed screen are intended to be a cross-screen movement operation or not. If the double confirm action is detected, then the mouse cursor may be moved to the adjoining display screen of the next display device at the appropriate location to thereby complete the cross-screen mouse movement operation. However, if the double confirm action is not detected within a given period of time, then the mouse cursor is not moved to the adjoining display screen, as the lack of the double confirm action indicates that the user is not intended to perform a cross-screen movement operation.

In addition, the illustrative embodiments provide mechanisms for automatically adjusting the dimensions of the margins at the periphery of a display screen based on user cross-screen behavior. That is, mechanisms are provided to determine when the user is encountering incorrect cross-screen movement of a mouse cursor. Such cross-screen behavior may be detected by tracking incidents where the user's mouse cursor crosses from one display screen to another, but the user then returns the mouse cursor to the original display screen within a given period of time of the cross-screen movement event. This indicates that the user did not intend for the mouse cursor to move from one display screen to the other. As a result of detecting such incidents, the margins at the locations around the periphery of the display screen where such incidents occur may be modified from default values to change the margin and lessen the likelihood of such incorrect cross-screen movement operations occurring in the future. In this way, the margins of the display screens may be adjusted for mouse sensitivity, human hand sensitivity, and user habits. Such modification of the margins at the various locations may result in non-uniform margins, e.g., non-rectangular margins.

Thus, the illustrative embodiments provide improved computing tools and improved computing tool operations/functionality that are specifically directed to solving problems with cross-screen mouse cursor movement in multiple display device configurations of computing systems. The illustrative embodiments provide both a double-confirm action mechanism for ensuring that the user intends to perform a cross-screen mouse cursor movement, as well as adaptive mechanisms for modifying the margins at locations around the periphery of the display screen so as to minimize unwanted or incorrect cross-screen mouse cursor movements, based on the user's cross-screen behavior history. With these mechanisms, the illustrative embodiments align the cross-screen mouse cursor movement operations with human intuition by providing an operation similar to the concept of “if you want to cross a wall, you need to touch and feel it first”. That is, if a user wants to move the mouse cursor from one display screen to another, they have to perform a first operation to “touch” the margin, and then a second operation to confirm movement through the margin to the other display screen.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a double-confirm action cross-screen movement engine for confirming whether a cross-screen movement is intended by a user, and an adaptive margin engine for adapting the margins of display screens based on user cross-screen behavior. The improved computing tool implements mechanisms and functionality, such as the double-confirm action cross-screen movement engine and the adaptive margin engine, which cannot be practically performed by human beings either outside of, or with the assistance of, a technical environment, such as a mental process or the like. The improved computing tool provides a practical application of the methodology at least in that the improved computing tool is able to minimize erroneous cross-screen movements of cursors and adapt margins of display screens in accordance with user cross-screen behavior.

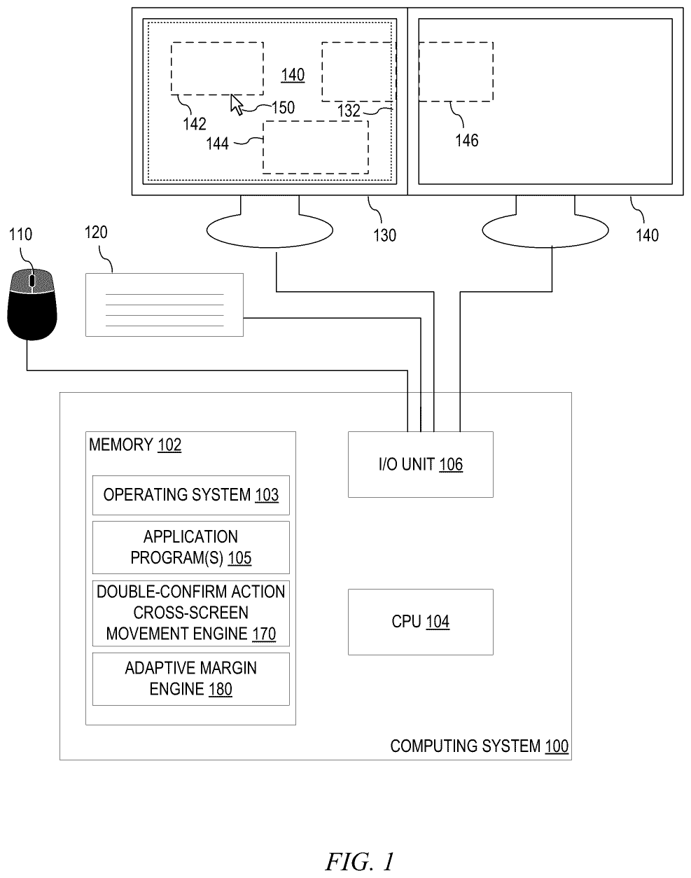

FIG. 1 is an example diagram of a data processing system in which aspects of the illustrative embodiments may be implemented and at least some of the computer code involved in performing the inventive methods may be executed. As shown in FIG. 1, a computing system 100 comprises, among other elements generally known to those of ordinary skill in the art, a central processing unit 104, an input/output unit 106, a memory 102 containing various programs used by the computing system 100, such as an operating system 103 and one or more application programs 105. A user of the computing system 100 communicates with the computing system 100 by way of a variety of different input devices, such as keyboard 120 and computer mouse 110. Other types of input devices may include trackballs, touchpads, stylus based devices, joystick devices, microphones, and the like, as are generally known to those of ordinary skill in the art. These input devices communicate information to the computing system 100 via an input/output unit 106. The computing system responds to user input in a variety of different ways, such as by providing responsive output to the user by displaying appropriate text, graphics, images, and the like, via the display devices 130, 160 and/or outputting audible outputs via one or more speakers or the like. The display devices 130, 160 may take many different forms including liquid crystal displays, light emitting diode (LED) based displays, or the like.

Operating systems often include a graphical user interface (GUI) by which the operating system and any applications it may be running, e.g., word processing programs, spreadsheet programs, web browsers, video games, and the like, may communicate with the user of the computing system 100. The GUI may be presented as a desktop in which the screen of a display device 130, 160 is regarded as a virtual desktop or two-dimensional workspace supporting various graphical objects in one or more display regions. As shown in FIG. 1, information is displayed on the desktop 140 within display regions 142-146, e.g., windows, dialog boxes, pop-up menus, pull-down menus, drop-down lists, icons, etc., which are typically rectangular in shape. Each display region 142-146 may be dedicated to a specific application or to the operating system under which the applications are executing. By manipulating a cursor 150, such as with point and click, drag and drop, or other generally known techniques, a user can manage the display regions 142-146 as desired, such as to create new display regions or eliminating ones that are no longer needed, resizing or repositioning the display regions 142-146, or the like. A user may activate a display region 142-146, and its associated application, for example, by clicking the cursor 150 when it appears within the desired region 142-146.

As shown in FIG. 1, the virtual desktop 140 and the display regions 142-146 along with the content displayed within these regions 142-146 may be spread across multiple different display devices 130 and 160 which are configured to operate on conjunction with each other via the operating system as a single unified desktop 140. That is, the operating system of the computing system 100 may provide functionality for linking multiple display devices 130, 160 to thereby extend the virtual desktop 140 and expand the available real estate of the virtual desktop 140 for greater viewing of content, e.g., more display regions 142-146, increased size of the displayed content, or the like. That is, the two, or more, displayed screens of the display devices 130, 160 are combined into a single contiguous display space and the user's movement of the cursor 150 may traverse this single contiguous display space with software mechanisms of the operating system tracking the movement of the cursor within the single contiguous display space. In general, using multiple display devices 130, 160 in a multi-screen manner can assist with problems of screen clutter and the need to display multiple different types of content at substantially the same time.

Such dual screen configurations, or multiple display/multiple monitor configurations, are generally known in the art. With such multiple displays, after configuring the multiple displays via the operating system's interface, the operating system monitors movement of the cursor on the desktop 140 and in the desired regions 142-146 to track the movement of the cursor as it moves within the screen provided by a single display device 130 or 160, and as the movement of the cursor traverses the boundary between the two display devices 130, 160. This tracking of movement involves the use of driver software and the like, installed in the operating system, that detects the movement of a user interface device, e.g., computer mouse, trackball, touchpad, stylus based devices, joysticks, or the like, and determines start and end positions of the cursor movement over time. Based on the movement of the input device, the graphical cursor 150 position is updated on the displayed screen in the displayed space, whether that be on one display device 130 or the other 160.

As noted above, a problem exists in existing multiple display device configurations of computing systems in that due to hand sensitivity of the user, input device sensitivity, or other factors, users working in areas near the periphery 132 of one display screen, e.g., the portion of the display screen represented on display device 130, may inadvertently have the cursor jump to the other display screen of the other display device 160 as the operating system and software determine that the user is moving the cursor 150 from one display screen of one display device 130 to the other 160. This is referred to herein as the “cross-screen” problem as it is referring to the problem of incorrectly determining that a user is intending to cross from one screen to the other in a multiple display device display. The cross-screen problem makes it difficult for users to work in the margins or at the edges of a displayed screens of display devices 130, 160, and leads to a portion of the displayed area at the periphery of each of the screens that cannot be easily utilized without significant frustration on the part of the user.

The illustrative embodiments address this issued by further configuring the operating system 103 with software, drivers, or the like, and/or providing an additional application program 105, that specifically implements a double-confirm action cross-screen movement engine 170 that operates to monitor cursor movements and enforce a double-confirm action requirement before transitioning the cursor from one display screen to another in a multiple display device configuration. In addition, in some illustrative embodiments, the operating system 103 is further configured with software, drivers, or the like, and/or an additional application program is provided, that specifically implements an adaptive margin engine 180 that adapts margins of a display screen in accordance with a user's historical cross-screen behavior. These mechanisms operate to minimize the cross-screen problem by minimizing occurrences of situations where the cursor is incorrectly moved from one display screen to the other when the user did not intend such a cross-screen movement.

As shown in FIG. 1, the computing system 100 may be specifically configured to implement the double-confirm action cross-screen movement engine 170 and the adaptive margin engine 180. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of the computing device 100 for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates confirming detected cross-screen movements of cursors and adapting margins to the user's previous cross-screen behavior and indications of erroneous cross-screen movements.

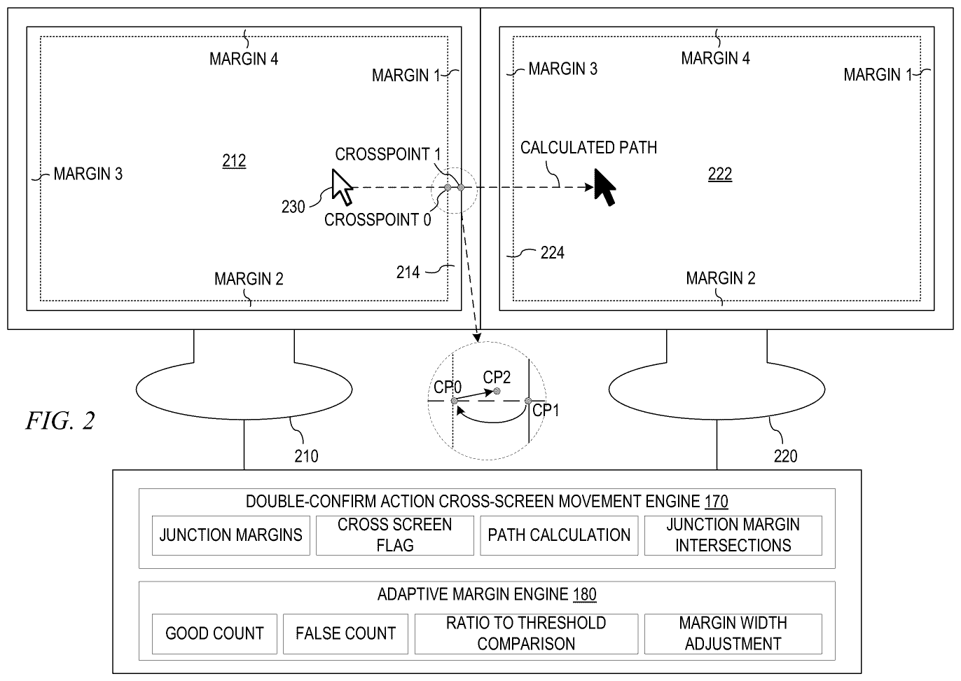

FIG. 2 is an example diagram illustrating a cross-screen mouse cursor movement detection operation based on a double confirm action in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., computer mouse movements being provided as input to the computing system, and the resulting output may aid human beings, e.g., the responsive output on the display screen showing the location of the cursor due to the movement of the computer mouse. The invention is specifically directed to the automatically operating computer components directed to improving the way that cross-screen movement operations are performed, and providing a specific solution that implements a double-confirm action cross-screen movement engine and adaptive margin engine which cannot be practically performed by human beings as a mental process and is not directed to organizing any human activity.

FIG. 2 shows an example of a dual display device configuration in which there are two display devices 210, 220, such as two computer monitors, that are configured to operate as a multiple display device configuration such that a contiguous desktop or display is presented that crosses the screens of the two display devices 210, 220. While FIG. 2 depicts an example with only two display devices 210, 220 that are physically located horizontally adjacent or in close proximity to each other, the illustrative embodiments are not limited to such. To the contrary, any number of display devices may be combined in both horizontal and vertical adjacency or proximity to each other to generate any size or configuration of combined contiguous display. Thus, in some cases, vertical motion of a cursor may cause a cross-screen operation from a lower display device to a higher display device, or vice versa.

As shown in FIG. 2, each of the display devices 210, 220 have a display screen 212 and 222 which provide textual/graphical output, such as a portion of a virtual desktop spanning the two display devices 210, 220. Each display screen 212, 222 has a periphery portion 214, 224 which is comprised of four margins 1-4 on each of the sides of the display screen 212, 222. For example, starting on the right hand side of display device 210, margin 1 is shown, and then following clockwise around the display screen 212, margins 2, 3, and 4 are represented. A similar configuration is presented with regard to display screen 222 such that margin 1 of display screen 212 is in closest proximity to margin 3 of display screen 222 in this example. The example of FIG. 2 assumes that the display screens 212 and 222 have a rectangular shape, and thus, there are 4 margins corresponding to the 4 sides of the rectangle, however this is not required. If a display screen 212, 222 of a different shape having more or fewer sides is utilized, the number of margins may be commensurate with the sides of the particular display screen 212, 222 shape, e.g., a hexagonal display screen 212 will have 6 margins.

Margins of a display screen 212 that are potentially virtually connected or adjoining with the margins of the other display screen(s) 222 are referred to herein as junction margins, or JunctionMargin. For example, in the depiction of FIG. 2, margin 1 of display screen 212 is a junction margin with margin 3 of display screen 222, which is also a junction margin, i.e., JunctionMargins=[margin1, margin3]. Assuming a rectangular configuration, a display screen 212, 222 may have between 0 and 4 junction margins. The junction margins will be used with the cursor movement to determine if a cross-screen cursor motion is potentially occurring, as discussed hereafter.

The double-confirm action cross-screen movement engine 170 implements a cross screen movement flag, referred to as CrossScreenFlag, which is used to flag when a potential cross-screen movement of the cursor on a display screen is detected to have occurred. Initially, the CrossScreenFlag is set to “null” meaning that no cross-screen movement has been detected. While the CrossScreenFlag is null, path detection of each mouse movement event is performed in a manner generally known in the art. That is, as the user moves the user interface device, e.g., the computer mouse, the signals sent from the user interface device are interpreted by the driver software and used to calculate a path of the movement of the cursor 230 on the display screens 212, 222. In calculating the path of movement, the driver software determines the start point coordinates StartPoint (x,y) and end point coordinates EndPoint (x,y) for the detected movement. Based on the calculated path, the double-confirm action cross-screen movement engine 170 compares the calculated path to the coordinates of the junction margins to determine if the calculated path cross any point in the junction margins. This may be done with regard to any point in the junction margin region 214 of display screen 212. In some illustrative embodiments, the determination is with regard to outer edge points of the junction margin region 214, e.g., CrossPoint 1 of junction margin 1 of display screen 212.

If the calculated path does not cross any point in the junction margins, then the mouse movement and corresponding cursor movement on the display screen 212 is performed in a normal manner. However, if there is a detected intersection between the calculated path and the junction margin region 214, then the CrossScreenFlag is set for that junction margin region 214, e.g., CrossScreenFlag=Marginx where Marginx is the junction margin region 214, such as margin 1 of display screen 212. In response to the calculated path crossing a junction margin region 214, such as at CrossPoint 1, the cursor 230 is returned to the inner border of the margin, e.g., CrossPoint 0. That is, the cursor 230 is moved back to an inner border to allow for a double-confirm action to be input by the user by continuing to move the cursor 230 towards the second display screen 222.

That is, when the CrossScreenFlag is set to a junction margin value, e.g., Marginx, a timer is set, e.g., a countdown time period of 2 seconds or the like is set, within which a double-confirm action may be detected to confirm that the user intends to move the cursor 230 to the second display screen 222. That is, the mouse events occurring within the time period count down by the timer are evaluated to calculate the path of the mouse event and determine if the junction margin is again intersected by the mouse event's calculated path of movement. If the mouse events do not include a movement of the mouse and corresponding movement of the cursor 230 such that the calculated path of movement again intersects the junction margin within the time period of the timer, then the timer may be allowed to expire. The timer may be reset to the specified time period, e.g., 2 seconds, upon the detection of a subsequent junction margin intersection by subsequent calculated paths of movement by subsequent mouse events.

Thus, for each mouse event, the path on the screens is calculated to get the start point and endpoint coordinates of the cursor 230 movement, e.g., StartPoint (x,y) and EndPoint (x,y), and these points are compared to the points of the junction margin of marginx set in the CrossScreenFlag to determine if the user is continuing to move the cursor 230 through the junction margin. Put another way, the junction margin, Marginx, specified in the CrossScreenFlag, is checked to determine if the junction margin has two cross points, Crosspoint 1 (CP1) and a subsequent Crosspoint 2 (CP2) after moving the cursor back to Crosspoint 0 (CP0), with the path of the mouse event's calculated path of movement. If so, then it is determined that the user intends to move the cursor 230 to the second display screen 222 and thus, the cursor 230 is moved to the EndPoint (x,y) in the second display screen 222, e.g., position 240 in FIG. 2. The CrossScreenFlag is then set back to a null value until a next detected potential cursor 230 movement crossing a junction margin.

In some illustrative embodiments, the mechanisms of the illustrative embodiments may dynamically modify the appearance of the cursor 230 on the display screen 212 when the double-confirm action detection and first timer are set so as to visually display to the user that the double-confirm action is being required to perform the cross screen movement operation of the cursor. Any suitable graphical representation that may be used to indicate the need for the double-confirm action may be utilized without departing from the spirit and scope of the present invention, e.g., a stick man pushing against a wall, a shaking mouse, a spinning hourglass, a cursor with a question mark coupled to the cursor, or the like.

It should be appreciated that this cross point detection and double-confirm action check is performed with regard to the defined junction margins. For margins that are not junction margins, normal operations of mouse movement are performed, e.g., if a user attempts to move the cursor 230 beyond a margin that is not a junction margin, the cursor 230 is kept at the outside boundary of the margin as there is no adjacent display screen to which to move the cursor 230.

Thus, the illustrative embodiments provide a mechanism for performing a confirmation that users wish to move their cursor from one display screen 212 to another display screen 222 in a multiple display device configuration in which the display screen areas are combined to provide a single display screen area spanning the multiple display devices. In particular, the illustrative embodiments provide specific algorithms that operate with algorithms and driver software of user interface devices, such as a computer mouse, to perform a double-confirm action cross-screen movement detection based on the calculated path of movement of a cursor 230 corresponding to the physical movement of the user interface device, e.g., computer mouse. The illustrative embodiments operate to move the cursor 230 back to an inner boundary of an intersected junction margin, setting a timer for a double-confirm action detection, and then detects whether the double-confirm action occurs within the time period of the timer. If such a double-confirm action occurs within the time period, then the cursor 230 is moved to the end point in the second display screen 222. If such a double-confirm action does not occur within the time period, then the cursor 230 is not moved to the end point of the second display screen 222.

As discussed above, the double-confirm action mechanisms operates based on the establishment of margins at the periphery of the display screens 212, 222. However, it is noted that users may have different behaviors and sensitivities with regard to operating near the margins of the display screen 212, 222, and such behaviors and sensitivities may differ at different points around the periphery of the display screens 212, 222. Normally, the margins of a display screen 212, 222 may be uniform around the periphery, e.g., 20 pixels margin size. However, with user daily usage, the illustrative embodiments provide mechanisms for collecting data about user margin behavior and margin crossing actions, which may be used to adjust the margin width at various points around the periphery of the display screen 212, 222 so as to minimize incorrect identification of a cross-screen movement action, i.e., incorrectly determining that the user is intending to move a cursor from one display screen 212 to another 222.

That is, for example, the adaptive margin engine 180 may operate to collect data representing cross-screen behaviors of users that may be indicative of whether a cross-screen movement of a cursor 230 was in fact intended or not intended, at each portion of each junction margin. That is, when a cross-screen movement occurs with a cursor 230, a second timer may be set to determine if the user inputs a subsequent mouse event that has a path of movement that moves the cursor 230 back to the original display screen, e.g., if the cursor 230 is moved from display screen 212 to display screen 222, and the user then moves the cursor 230 back to display screen 212 within a given period of time specified by the second timer, it may indicate that the user did not intend to move the cursor 230 to the second display screen 222. This may occur due to mouse sensitivity, the user's physical ability to make fine hand movements, or the like.

In one illustrative embodiment, to identify such mistaken cross-screen movements, the adaptive margin engine 180 may, for each portion of a junction margin, count how many times the user performs a cross-screen movement of the cursor 230 from one display screen 212, to another display screen 222, and then performs operations within the second display screen 222. This is referred to as a GoodCount, meaning that the cross screen movement was in fact a valid cross screen movement intended by the user. In addition, the adaptive margin engine 180 may, for each portion of a junction margin, count how many times the user performs a cross-screen movement of the cursor 230 from one display screen 212, to another display screen 222, and then crosses back to the original display screen 212 within a given period of time of the second timer without any other operation in the second display screen 222. This is referred to as a FalseCount, meaning that the cross screen movement was not a valid cross screen movement intended by the user. If the ratio of FalseCount to the total count, i.e., GoodCount+FalseCount, is equal to or greater than a predetermined threshold, then it may be determined that there are too many false cross screen movement operations at that portion of the margin and the margin may be increased in size so as to minimize false cross screen movement operations. The amount of the increase may be predetermined, e.g., increase margin by 5 pixels, or may be a function of the amount of the ratio, for example. For example, in some illustrative embodiments, the margin width at a point y may be determined from Width (y)=((FalseCount (y)*defaultWidth)/(GoodCount (y)+FalseCount (y)))*Factor, where defaultWidth is the default width of the junction margin, e.g., 20 pixels, and Factor is a width expansion factor that indicates how much to increase the size of the junction margin based on the ratio.

The portions of the junction margins that may be evaluated using the counts may take many different forms. In some illustrative embodiments, the junction margins may be kept uniform size such that the entire junction margin size is controlled to increase the size of the entire junction margin. In other illustrative embodiments, the portions may represent sub-sections of the junction margins which may be individually adjusted and thereby cause the junction margin to be non-uniform. In some illustrative embodiments, the counts may be maintained for each pixel along the outer boundary of the periphery of the junction margin. As a result, the margins of the display screen 212, 222 may have non-uniform widths and may not be rectangular.

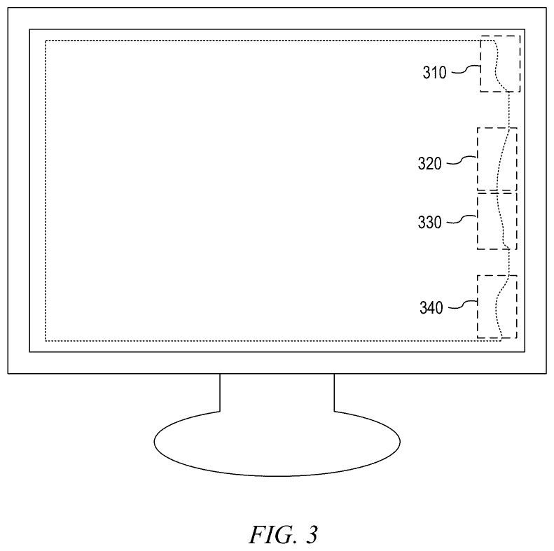

FIG. 3 is an example diagram of a non-uniform display screen margin generated in accordance with one illustrative embodiment. As shown in FIG. 3, various portions 310-340 of the margin around the periphery of the display screen 212 have different widths. This allows the margins to be dynamically adapted to the sensitivities of the user and the mouse settings and reduce frustration on the part of the user due to incorrect or mistaken cross screen movement operations.

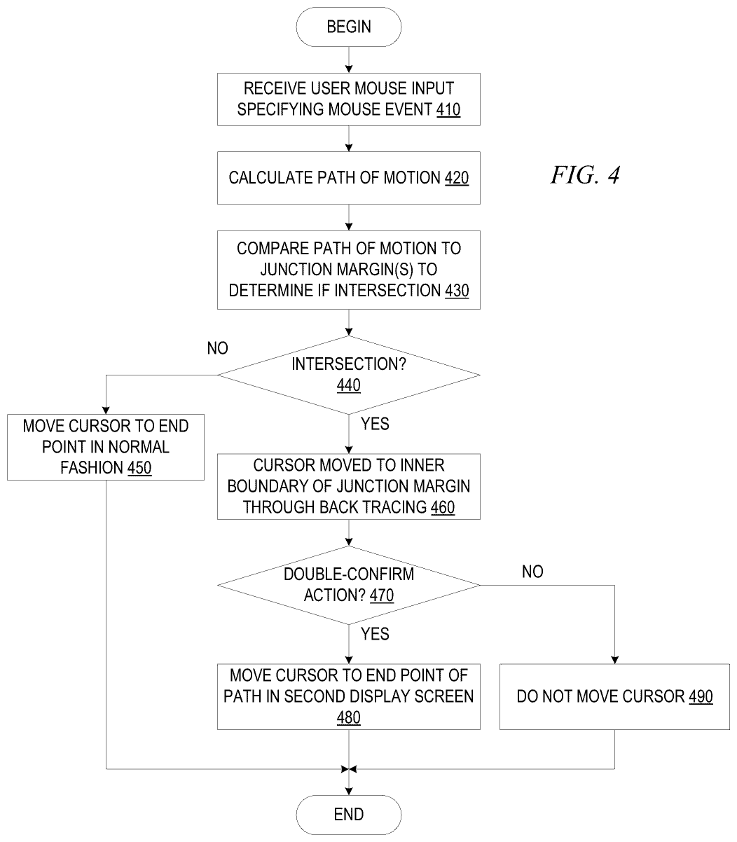

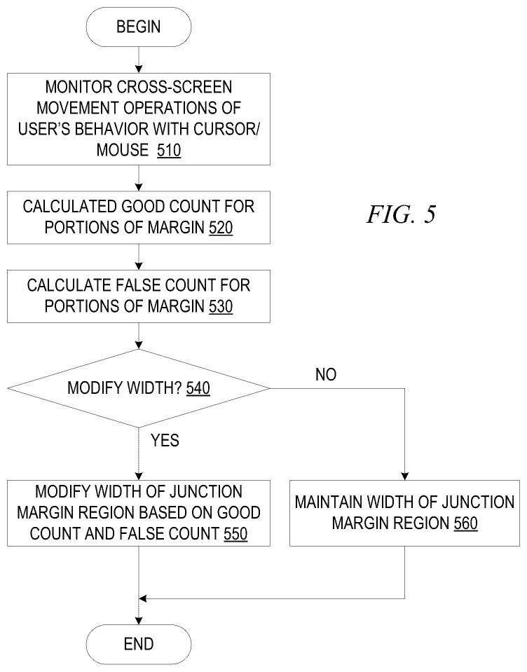

FIGS. 4-5 present flowcharts outlining example operations of elements of the present invention with regard to one or more illustrative embodiments. It should be appreciated that the operations outlined in FIGS. 4-5 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 4-5, and may, in some cases, make use of the results generated as a consequence of the operations set forth in FIGS. 4-5, the operations in FIGS. 4-5 themselves are specifically performed by the improved computing tool in an automated manner.

FIG. 4 is a flowchart outlining an example operation for performing a cross-screen mouse cursor movement operation based on a double confirm action in accordance with one illustrative embodiment. The operation starts by receiving user mouse input specifying a mouse event (step 410). A path of motion of the cursor is calculated from the mouse event (step 420). The path of motion is compared to the points of the junction margins of a first display screen of a first display device to determine if the path of motion intersects a junction margin of the first display screen (step 430). If the path of motion does not intersect the junction margin (step 440), the cursor is moved to the end point of the path of motion in accordance with a normal mouse/cursor movement (step 450). If the path of motion does intersect a junction margin, the cursor is moved to the inner boundary of the junction margin by back tracing the path of motion to the inner boundary point, and a first timer is set (step 460). A determination is made as to whether an addition subsequent mouse event with calculated path of motion also intersects the junction margin within the time period of the first timer, which is referred to as the double-confirm action (step 470). If so, then the cursor is moved to the end point of the path of motion in a second display screen of a second display device (step 480). If the double-confirm action is not detected within the time period of the first timer, then the cursor is not moved to the end point in the second display screen of the second display device (step 490). The operation then terminates.

FIG. 5 is a flowchart outlining an example operation for automatically adjusting margin dimensions of a display screen based on user cross-screen behavior in accordance with one illustrative embodiment. As shown in FIG. 5, the operation starts by monitoring cross-screen movement operations of a user's behavior with a cursor/mouse of a computing device (step 510). Based on the monitoring, a first count, referred to as the GoodCount, is calculated when the user's behavior indicates a cross-screen movement operation from a first display screen to a second display screen, that is followed by a subsequent operation within the second display screen (step 520). Based on the monitoring, a second count, referred to as the FalseCount, is calculated when the user's behavior indicates a cross-screen movement operation from a first display screen to a second display screen, followed by a subsequent operation within a second timer time period, that is a cross-screen movement operation from the second display screen to the first display screen (step 530). A determination is made as to whether a value calculated based on the GoodCount and FalseCount indicates a need to modify a width of a junction margin of the first display screen (step 540). If so, then a width of the junction margin is modified based on the GoodCount and FalseCount (step 550). If not, then the width is maintained (step 560) and the operation terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for performing cross-screen movement operations in a multiple display device computer configuration, the method comprising:
receiving, from a user interface device, an input specifying a movement of a displayed element on a first display screen of the multiple display device computer configuration;
calculating a path of motion of the displayed element based on the input;
comparing the path of motion to a junction margin of the first display screen to determine if the path of motion intersects the junction margin, wherein the junction margin is a margin of the first display screen that virtually adjoins a margin of a second display screen of the multiple display device computer configuration;
in response to the path of motion intersecting the junction margin, placing the displayed element at a first point of the junction margin; and
in response to receiving a subsequent input having a subsequent path of motion that intersects the junction margin, performing a cross-screen movement operation to move the displayed element to an end point of the subsequent path of motion in the second display screen.

2. The method of claim 1, wherein the user interface device is one of a computer mouse coupled to the data processing system.

3. The method of claim 1, further comprising:
initiating a timer in response to the determining that the path of motion intersects the junction margin, wherein the timer counts down a period of time from a predetermined timer value; and
monitoring for the subsequent input within the period of time measure by the timer.

4. The method of claim 1, wherein the first point of the junction margin is a point on an inner boundary of the junction margin.

5. The method of claim 1, wherein the first display screen is displayed by a first display device and the second display screen is displayed by a second display device, and wherein the junction margin is one of a vertical margin virtually adjoining the margin of the second display screen which is also a vertical margin, or a horizontal margin virtually adjoining the margin of the second display screen which is also a horizontal margin.

6. The method of claim 1, further comprising:
logging, over time, historical incorrect cross-screen movement operations, wherein an incorrect cross-screen movement operation is a cross-screen movement operation that occurs and there is a movement of the displayed element from the second display screen back to the first display screen within a predetermined period of time after the cross-screen movement operation.

7. The method of claim 6, further comprising adjusting at least one dimension of the junction margin based on the logged historical incorrect cross-screen movement operations.

8. The method of claim 7, wherein logging historical incorrect cross-screen movement operations is performed for each of a plurality of portions of the junction margin, and wherein adjusting at least one dimension of the junction margin is performed for each portion, of the plurality of portions, of the junction margin based on the logged historical cross-screen movement operations associated with that portion of the junction margin.

9. The method of claim 8, wherein, after performing the adjusting for each portion of the plurality of portions of the junction margin, the junction margin has a non-uniform configuration such that some portions have larger or smaller dimensions than other portions.

10. The method of claim 1, further comprising:
accumulating, over time, a false cross-screen count which is a count of how many times a first cross-screen movement operation occurs followed by a second cross-screen movement operation to return the displayed element from the second display screen to the first display screen, within a predetermined period of time of the first cross-screen movement operation;
accumulating, over time, a good cross-screen count which is a count of how many times the first cross-screen movement operation occurs and the second cross-screen movement operation does not occur within the predetermined period of time of the first cross-screen movement operation;
determining a value of a function of the good cross-screen count and the false cross-screen count; and
adjusting a dimension of the junction margin based on the value of the function.

11. A computer program product comprising a computer readable storage medium having a computer readable program stored therein, wherein the computer readable program, when executed on a computing device, causes the computing device to perform cross-screen movement operations in a multiple display device computer configuration, at least by:
receiving, from a user interface device, an input specifying a movement of a displayed element on a first display screen of the multiple display device computer configuration;
calculating a path of motion of the displayed element based on the input;
comparing the path of motion to a junction margin of the first display screen to determine if the path of motion intersects the junction margin, wherein the junction margin is a margin of the first display screen that virtually adjoins a margin of a second display screen of the multiple display device computer configuration;
in response to the path of motion intersecting the junction margin, placing the displayed element at a first point of the junction margin; and
in response to receiving a subsequent input having a subsequent path of motion that intersects the junction margin, performing a cross-screen movement operation to move the displayed element to an end point of the subsequent path of motion in the second display screen.

12. The computer program product of claim 11, further comprising:
initiating a timer in response to the determining that the path of motion intersects the junction margin, wherein the timer counts down a period of time from a predetermined timer value; and
monitoring for the subsequent input within the period of time measure by the timer.

13. The computer program product of claim 11, wherein the first point of the junction margin is a point on an inner boundary of the junction margin.

14. The computer program product of claim 11, wherein the first display screen is displayed by a first display device and the second display screen is displayed by a second display device, and wherein the junction margin is one of a vertical margin virtually adjoining the margin of the second display screen which is also a vertical margin, or a horizontal margin virtually adjoining the margin of the second display screen which is also a horizontal margin.

15. The computer program product of claim 11, further comprising:
logging, over time, historical incorrect cross-screen movement operations, wherein an incorrect cross-screen movement operation is a cross-screen movement operation that occurs and there is a movement of the displayed element from the second display screen back to the first display screen within a predetermined period of time after the cross-screen movement operation.

16. The computer program product of claim 15, further comprising adjusting at least one dimension of the junction margin based on the logged historical incorrect cross-screen movement operations.

17. The computer program product of claim 16, wherein logging historical incorrect cross-screen movement operations is performed for each of a plurality of portions of the junction margin, and wherein adjusting at least one dimension of the junction margin is performed for each portion, of the plurality of portions, of the junction margin based on the logged historical cross-screen movement operations associated with that portion of the junction margin.

18. The computer program product of claim 17, wherein, after performing the adjusting for each portion of the plurality of portions of the junction margin, the junction margin has a non-uniform configuration such that some portions have larger or smaller dimensions than other portions.

19. The computer program product of claim 11, further comprising:
accumulating, over time, a false cross-screen count which is a count of how many times a first cross-screen movement operation occurs followed by a second cross-screen movement operation to return the displayed element from the second display screen to the first display screen, within a predetermined period of time of the first cross-screen movement operation;
accumulating, over time, a good cross-screen count which is a count of how many times the first cross-screen movement operation occurs and the second cross-screen movement operation does not occur within the predetermined period of time of the first cross-screen movement operation;
determining a value of a function of the good cross-screen count and the false cross-screen count; and
adjusting a dimension of the junction margin based on the value of the function.

20. An apparatus comprising:
at least one processor; and
at least one memory coupled to the at least one processor, wherein the at least one memory comprises instructions which, when executed by the at least one processor, cause the at least one processor to perform cross-screen movement operations in a multiple display device computer configuration, at least by:
receiving, from a user interface device, an input specifying a movement of a displayed element on a first display screen of the multiple display device computer configuration;
calculating a path of motion of the displayed element based on the input;
comparing the path of motion to a junction margin of the first display screen to determine if the path of motion intersects the junction margin, wherein the junction margin is a margin of the first display screen that virtually adjoins a margin of a second display screen of the multiple display device computer configuration;
in response to the path of motion intersecting the junction margin, placing the displayed element at a first point of the junction margin; and
in response to receiving a subsequent input having a subsequent path of motion that intersects the junction margin, performing a cross-screen movement operation to move the displayed element to an end point of the subsequent path of motion in the second display screen.
